(19) United States
(12) Patent Application Publication
(10) Pub. No.: US 2010/0325903 A1
(43) Pub. Date: Dec. 30, 2010

(54) Hand-held circular saw, in particular plunge-cut saw

(76) Inventor: Chetan Patel, North Oaks, MN (US)

Correspondence Address: Spriegel and Associates, 110 West Streetsboro Street, L4 and L14, Hudson, OH, 44236, US

(21) Appl. No.: 12/799,165

(22) Filed: Apr. 20, 2010

Related U.S. Application Data
(62) Division of application No. 11/569,745, filed on Sep. 24, 2007, now abandoned.
Application No. 11/569,745 is a continuation-in-part of application No. PCT/US05/19041, filed on May 31, 2005.
Application No. PCT/US05/19041 is a continuation-in-part of application No. 12/556,239, filed on Sep. 9, 2009.

(51) Int. Cl. B23D 47/08; B27G 19/04; B23D 45/16

(52) U.S. Cl. 30/377; 30/390

(57) ABSTRACT

A plunge saw comprising a body housing enclosing a motor wherein the plunge saw rotates about a forward pivot point while a lower cutting base bottom planar surface remains in contact with a workpiece. A saw blade is operatively coupled to the motor, wherein the saw blade plunges into a workpiece in a rotational arc thereby exerting both a lateral and vertical force that reduces the likelihood of saw kick back. The saw can be turned on, operated and turned off with a single hand.

### CROSS REFERENCE TO RELATED APPLICATIONS

This application is a continuation in part of copending patent application HAND-HELD CIRCULAR SAW, IN PARTICULAR PLUNGE-CUT SAW, PCT app. serial number PCTUS2005019041 and U.S. application Ser. No. 11/569,745.

### FIELD OF INVENTION

The invention relates generally to power tools, and more specifically to a plunge cut circular saw.

### BACKGROUND OF THE INVENTION

Traditional plunge cut and/or circular saws are large, bulky, do not have a balanced center-of-gravity when held in the operator's hand which therefore results in operator arm fatigue especially when cutting in a vertical (e.g., wall) or overhead (e.g., ceiling) position. The traditional saws operate with a motor which turns an output shaft which is perpendicularly positioned to the saw blade and saw blade guard assembly. The prior art saws are typically controlled by a main handle that is positioned perpendicular to the output shaft of the motor. When not operating, the blade's cutting surface is concealed by a fixed blade guard over the top of the tool's base, and a movable spring-loaded guard below the base that rotates to expose the blade as the cut is made. This feature makes it awkward to plunge cut (cutting into a work piece rather than beginning the cut from the edge of that piece).

Various prior art attempts have been made to develop saws for plunge cutting. Some of these have focused on circular saws, while others have focused on plunge cut type saws. However, all of those prior art attempts have various limitations and disadvantages, and the present invention provides improvements over these prior art devices.

U.S. Patent Application No. 2003/0024368 (Fukuoka) teaches a circular saw with a base/shoe 2 arranged and constructed to support the tool unit with respect to a workpiece. A major disadvantage of circular saws including this saw is that a blade guard must be manually lifted for plunge cutting and the saw's forward base/shoe edge then is rested on the workpiece while the rest of base/shoe is off of the workpiece. The forward base/shoe edge acts as a “fulcrum” as the blade is lowered (i.e., plunged) into the workpiece. This is a major disadvantage because without the entire lower planar surface on the workpiece the circular saw is unstable. In addition, it is difficult not to damage the workpiece during the cut due to jitter. It is also difficult to see how deep the blade plunges into the workpiece.

U.S. Pat. No. 4,414,743 issued Nov. 5, 1983 to Pioch teaches a prior art circular saw that suffers from the same disadvantages as U.S. Patent Application No. 2003/0024368 (Fukuoka) as discussed above and is large, bulky and heavy. It would be difficult to operate on a wall and/or ceiling. As shown in FIG. 4 (of Pioch) the motor is mounted perpendicular to a planar surface of the saw blade. With the motor offset from the handle there is an overturning torque on the operator's wrist/arm and therefore the operator's arm would fatigue quickly when operating or holding the saw against a wall or the ceiling.

U.S. Pat. No. 5,239,756 issued to Matzo et al. teaches a prior art circular saw that suffers from many of the disadvantages mentioned supra, as well as others. The motor is mounted perpendicular to the axis of an upper pistol type handle 7. This makes the circular saw bulky, excessively heavy and requires a second handle. In addition, the guard 63 is segmented into two halves 67 and 68 which separate in order to use the saw for plunge cutting. One of the limitations of Matzo et al., is that if rollers 70, 71 are not properly aligned with desired cut line on the workpiece, the rollers 70, 71, which allow motion perpendicular to the roller axis and inhibit lateral motion parallel to the roller axis, can direct the saw blade 27 along an undesired path and not on the desired cut line.

Notwithstanding these prior art saws, there continues to be a need for a light weight plunge saw, that can be entirely operated with a single hand, has a single handle, that allows the center-of-gravity of the plunge saw to be adjusted to reduce operator fatigue, where the entire lower base planar surface is in contact with the workpiece during the plunge cut, pivots about a frontward pivoting hinge and allows easy visualization of the cutting process.

### SUMMARY OF THE INVENTION

In one embodiment, the invention is directed to a light weight plunge saw that can be operated with one hand;

In another embodiment, the invention is directed to a light weight plunge saw, that has a single handle;

In a further embodiment, the invention is directed to a light weight plunge saw, which allows the center-of-gravity of the plunge saw to be adjusted manually or automatically during operation or non-operation;

In yet another embodiment, the invention is directed to a light weight plunge saw that pivots about a forward pivoting hinge;

In a further embodiment, the invention is directed to a transparent saw blade closure assembly and base that allows visualization of the cutting process;

In yet another embodiment, the invention the dust removal hose is smooth to reduce hose hanging up on an object;

In a further embodiment, the invention is to allow one hand to turn on the saw, one hand operation and allow one hand to turn off the saw, and the one hand can be the right or left hand;

In a further embodiment, the invention is directed to the saw wherein the saw blade guards do not have to be manually lifted to make a plunge cut;

It is a further embodiment of the invention directed at light weight plunge saw, wherein the entire lower base planar surface is in contact with the workpiece during the plunge cut; and

In a still further embodiment, the invention is directed to a light weight plunge saw that allows easy visualization of the cutting process.

### BRIEF DESCRIPTION OF THE DRAWINGS

FIG. 1 shows a side view of a saw according to one embodiment in accordance with an aspect of the present invention.

FIG. 2 shows another side view of the saw of FIG. 1 in accordance with another embodiment of the invention.

FIG. 3 shows another side view of the saw of FIG. 1 in accordance with another implementation of the invention.

FIG. 4 shows a partial perspective view of a portion of the saw of FIG. 1 according to yet another embodiment in accordance with an aspect of the present invention.

FIG. 5 shows a partial cut-away view of the saw of FIG. 1 in accordance with another aspect of the present invention.

FIG. 6 shows a partial cut-away view of the saw of FIG. 1 in accordance with another implementation of the invention.

FIG. 7 shows a partial cut-away perspective view of a portion of the saw of FIG. 1 in accordance with the invention.

FIG. 8 shows a partial cut-away view of a portion of the saw of FIG. 1 in accordance with yet another implementation or aspect of the present invention.

FIG. 9 shows a partial cut-away view of the saw of FIG. 1 in accordance with another embodiment of the present invention.

FIG. 10 shows a partial perspective view of the saw of FIG. 1 in accordance with another implementation of the invention.

FIG. 11 shows a partial cut-away perspective view of the saw of FIG. 1 in accordance with yet another implementation or aspect of the present invention.

FIG. 12 shows a partial cut-away perspective view of the saw of FIG. 1 in accordance with another embodiment of the present invention.

FIG. 13 shows an accessory for a saw, in accordance with yet another embodiment of the present invention.

FIG. 14 shows another view of the accessory of the saw illustrated in FIG. 13 in accordance with another implementation of the invention.

FIG. 15 shows an accessory for a saw, in accordance with another embodiment of the present invention.

FIG. 16 shows an accessory for a saw, in accordance with yet another embodiment of the present invention.

FIG. 17 shows another view of the accessory of FIG. 16 in accordance with another implementation of the invention.

FIG. 18 shows a partial perspective view of a saw, in accordance with another embodiment of the present invention.

FIG. 19 shows a partial side view of a saw, in accordance with another implementation of the invention.

FIG. 20 shows another side view of the saw of FIG. 19 in accordance with another implementation of the invention.

FIG. 21 shows a perspective view of the saw of FIG. 19 in accordance with another implementation of the invention.

FIG. 22 shows a perspective view of a guard lock of the saw of FIG. 19, in accordance with another embodiment of the present invention.

FIG. 23 shows a perspective view of a saw, in accordance with another embodiment of the present invention.

FIG. 24 shows a side view of a saw, in accordance with another implementation of the invention.

FIG. 25 shows a partial side view of the saw of FIG. 19 in accordance with another implementation of the invention.

FIG. 26 shows a perspective view of a saw of in accordance with another implementation of the invention.

FIG. 27 shows a perspective view of a saw, in accordance with another embodiment of the present invention.

FIG. 28 shows a perspective view of a portion of a saw in accordance with another implementation of the invention.

FIG. 29 illustrates a block diagram of operating a plunge saw with one hand, in accordance with another embodiment of the present invention.

### DETAILED DESCRIPTION OF THE INVENTION

One or more implementations of the present invention will now be described with reference to the attached drawings, wherein like reference numerals are used to refer to like elements throughout, and wherein the illustrated structures are not necessarily drawn to scale. The invention relates to plunge saws.

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilized and that structural changes may be made without departing from the spirit and scope of the present invention. The following detailed description is, therefore, not to be taken in a limiting sense, and the scope of the present invention is defined by the appended claims and their equivalents.

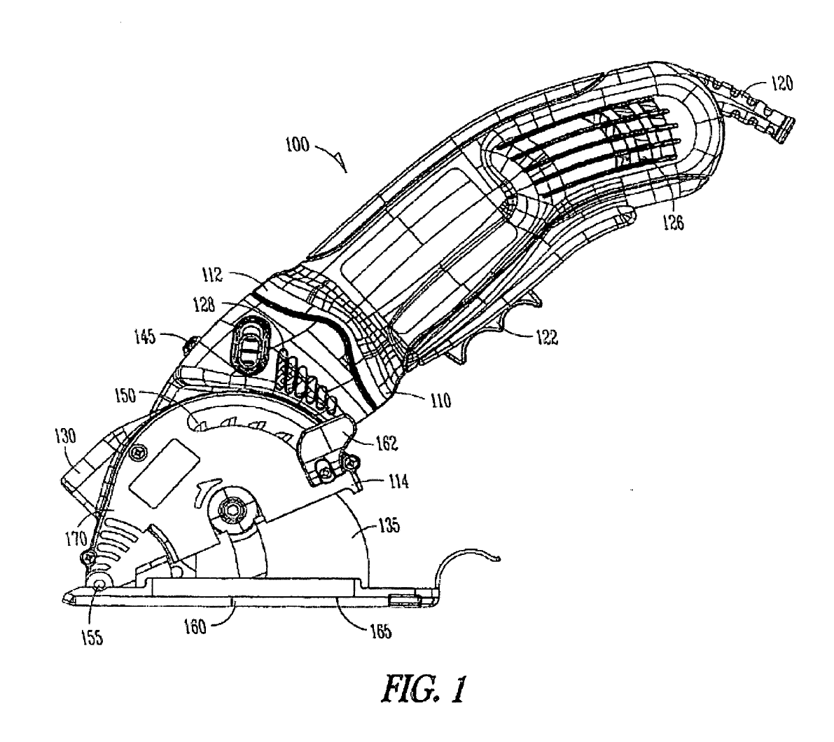

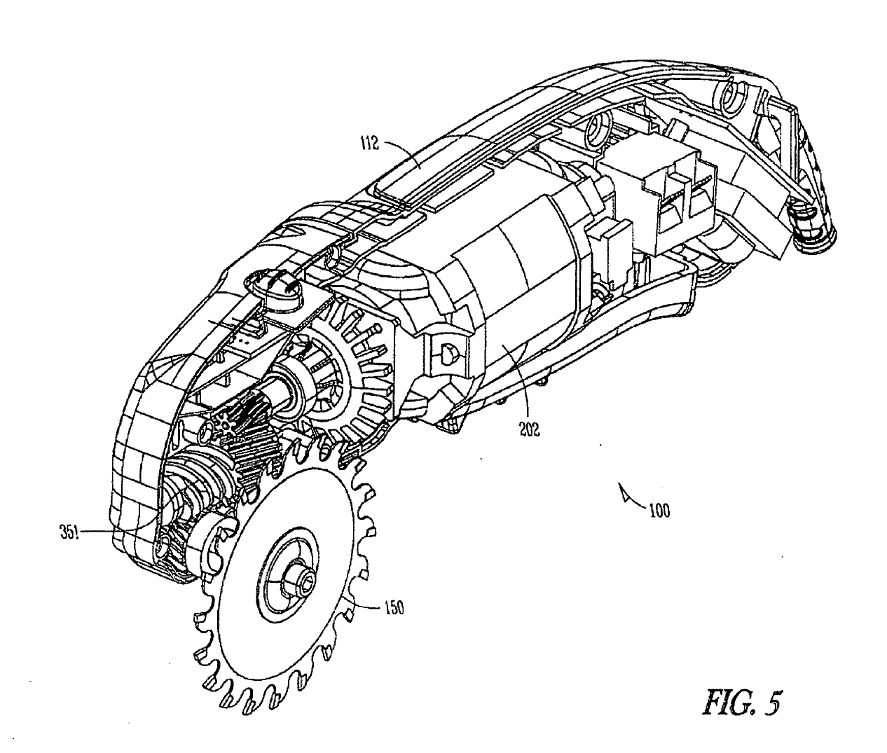

FIG. 1 shows a side view of a circular plunge saw 100, in accordance with one embodiment of the present invention. The saw 100 is a multi-purpose compact saw and generally includes a housing 110 which includes a body housing 112 and a cutting head 114. The body housing 112 can comprise plastic, ABS, metal, composites and the like. The body housing 112 encloses a motor 202 (FIG. 5) which is connected to a power cord 120 which is connectable to an AC or DC power source. In several embodiments, the motor 202 can run off of battery power, AC power, DC power and the like. The body housing 112 includes a switch 122 to activate the saw 100. One or more vents 126, 128 can be formed in the body housing 112 for cooling of the motor 202. The design of the saw 100 incorporates the motor 202 which is mounted within the body housing 112 of the saw 100, and a plurality of gears 351 (FIG. 5) which cause a circular blade 150 to operate in a parallel orientation to the motor's output shaft. This enables the much smaller and lighter weight plunge saw 100.

The saw 100 is dimensioned to be hand-held and operated with a single hand. An operator can grip the body housing 112 and can activate the switch 122 with a single hand. In some examples, the grip is designed for leveraging the saw 100 in the cutting direction. Additionally, soft grip features can be incorporated into the body housing 112 for both aesthetic reasons, operator comfort and to reduce operator fatigue. In one example, the body housing 112 is made of Nylon 6 and the cutting head 114 is a cast magnesium with a metal base 160 attached. The over molding material can be Santoprene™, for example of a relatively high durometer (75 A to 85 A), to resist wear and dirt impregnation, and resistant to hand acids, and petroleum based products. These embodiments are described in sufficient detail to enable those skilled in the art to practice the invention, and it is to be understood that the embodiments may be combined or that other embodiments may be utilized and that structural changes may be made without departing from the spirit and scope of the present invention.

Located on a front surface of the cutting head 114 is a light housing 130. The light housing 130 can include a laser cutting guide and an LED light for illumination, and which can be activated by a switch 145. The circular blade 150 is coupled to the body housing 112 with the cutting head 114 enclosing the blade 150. The cutting head 114 and a guard portion 135 fully surround the saw blade 150, when not in use. The cutting head 114 includes an upper guard 170 that covers the upper surface of the saw blade 150 and the saw 100 includes a lower cutting base 160. The cutting base 160 includes a cutting surface 165 and the guard portion 135 which partially surrounds and covers the lower portion of the saw blade 150. The cutting base 160 is rotationally coupled to the upper guard 170 of the cutting head 114 at a pivot point 155. A latch 162 (FIG. 1) is used to set the depth of cut of the saw blade 150. The cutting base 160 remains in contact with the workpiece as the saw blade 150 is plunged into the workpiece by rotating the saw 100 about the pivot point 155.

Referring to FIG. 1 the inventor(s) recognized that having a saw 100 that rotates around a pivot point 155 located in the forward end of the saw reduces or eliminates “kick back” wherein the saw 100 moves back towards the user. Kick back occurs when a rotating saw blade 150 engages with a workpiece in a manner which causes the saw blade 150 to jam in the workpiece. The resulting forces can cause the saw 150 to fly off the workpiece towards the user. By rotating the saw 100 about the front pivot point the user exerts a clockwise torque on the saw 100 which would resist a counterclockwise “kick back” torque providing greater stability and resistance to kick back. In contrast, when a traditional saw pivots about the back end of the saw the operator exerts a counterclockwise torque which adds to the kick back of the saw providing greater stability and resistance to kick back. In other words, the inventor(s) recognized that by designing the saw 100 of the present invention so that the saw blade 150 comes into contact with the workpiece both vertically and horizontally that the likelihood of “kick back” is reduced.

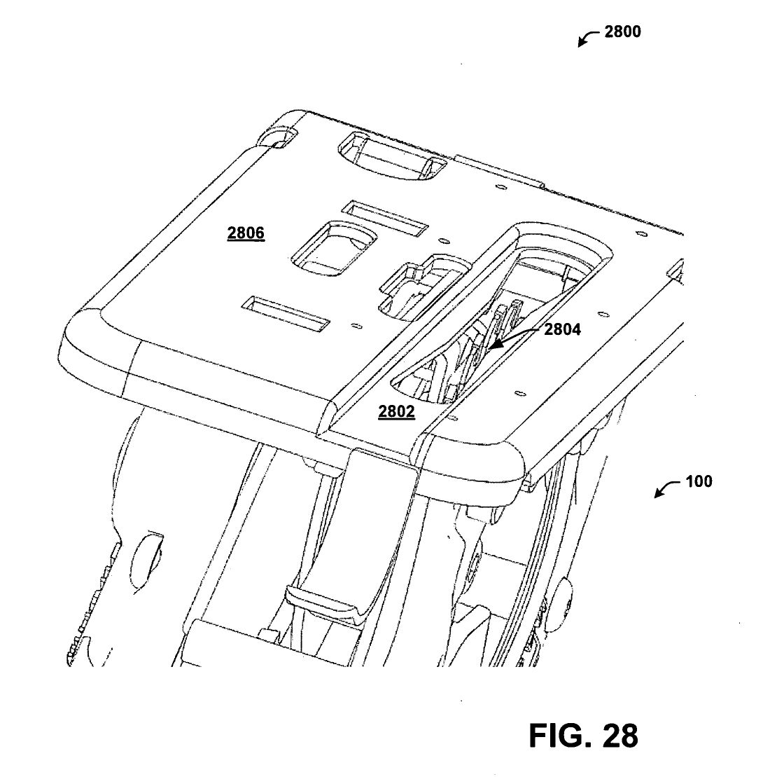

The inventor(s) also recognized in another embodiment that greater stability could be attained in the present invention with a bottom planar surface 2806 (FIG. 28) of the cutting base 160 (FIG. 1) remaining in contact with the work piece as the saw 100 rotates about the pivot point/axis 155 and the saw blade 150 comes into contact with the workpiece. Keeping the entire bottom planar surface 2806 of the cutting base 160 in contact with the workpiece allows the operator to plunge the saw blade 150 “evenly” and along a single axis into the workpiece, such as along a pencil line, for example without the “side to side jitter” that occurs with prior art circular saws wherein the prior art circular saws base has to be lifted onto an edge in order to make a plunge cut. The side to side jitter with prior art circular saws results in a jagged edge that must be reworked or the workpiece must be thrown away (e.g., U.S. Patent Application No. 2003/0024368 (Fukuoka) has a greater tendency to “jitter” than the present invention).

The inventor(s) also recognized the limitations of prior art U.S. Pat. No. 6,757,982 (Refson). In the case of prior art Refson, the blade 20 is moved downward vertically by the operator applying a force in one direction coming into contact with the workpiece in a perpendicular direction with respect to the workpiece, however the saw blade exerts both a vertical and horizontal force on the workpiece. Therefore, in Refson when the blade 20 contacts the workpiece the saw is more likely to “kick back” because the operator is pushing the blade 20 straight down and therefore the operator is not exerting a lateral force, rather just a vertical force.

The inventor(s) recognized that prior art U.S. Pat. No. 5,239,756 issued to Matzo et al. has numerous limitations. One of those limitations of the prior art Matzo et al., occurs if rollers 70, 71 are not properly aligned to move parallel with the desired cut line on the workpiece. The rollers 70, 71 (which allow motion perpendicular to the roller axis) can inhibit lateral motion which can direct the saw blade 27 along an undesired path. The inventor(s) recognized with the present invention that by designing the saw 100 with the entire planar bottom surface 2806 (FIG. 28) of the cutting base 160 in contact with the workpiece that the saw's 100 path in an axial or lateral path is not inhibited or inhibited to a very small extent, as opposed to prior art Matzo et al. by the rollers 70, 71.

In various examples, as illustrated in FIG. 1, the body housing 112 allows the user to grip the saw 100 during normal use. The power/speed control switch 122 is centrally located at the bottom of the saw to be convenient to operate with either hand. In other words, the power/speed control switch 122 is located such that it can be activated with either hand, allowing one-handed operation. A double action (trigger with secondary interlock) can be utilized as a safety measure. Alternatively, other types of switches may be employed and are contemplated as falling within the scope of the present invention.

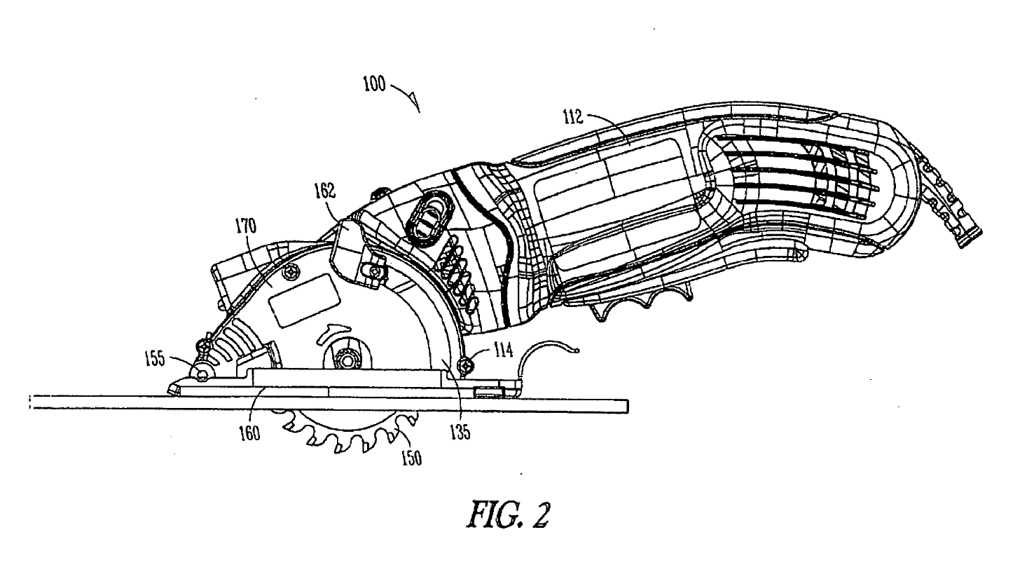

FIG. 2 shows a saw 100 in use as the planar bottom surface of the cutting base 160 remains in contact with the workpiece as the saw 100 rotates about the pivot point 155. A body housing 112 rotates downwards along with an upper guard 170 until a guard portion 135 contacts a latch 162. In this example, the latch 162 is set at a full depth of cut. The saw 100 pivots from the front (nose) giving the operator visual cues that the saw 100 is to be placed with the front (nose) in contact with the workpiece—and then plunging the saw blade 150 by pivoting the saw 100 downward. In other words, FIG. 2 shows the saw 100 in use as an entire planar bottom surface of the cutting base 160 remains in contact with the workpiece as the saw 100 rotates about the forward pivot point 155.

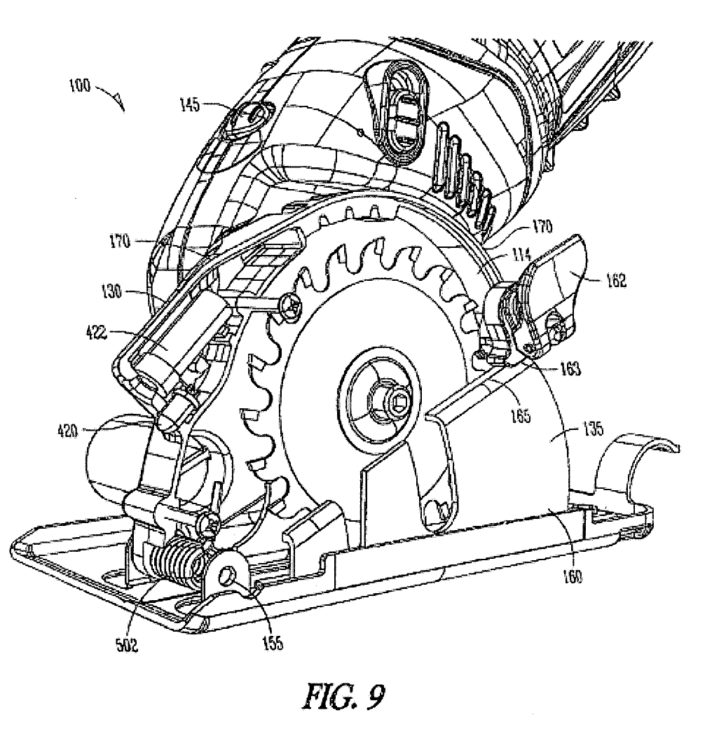

Referring again to FIG. 1, the cutting head 114 (See e.g., FIG. 9) conceals the saw blade's cutting surface fully above the cutting base 160 when not in use. The saw blade 150 is exposed underneath the base 160 during cutting by pushing the body housing 112 (FIG. 1) of the saw 100 down the toward base 160 pivoting about the pivot point 155, wherein the saw 100 pushes against the resisting tension of a torsion spring 502 (FIG. 9) located between base 160 and upper guard 170 (FIG. 1). In this embodiment, the spring 502 is located at the pivot point 155. In other examples, the spring 502 can be located anywhere along the area between base 160 and upper guard 170. Accordingly, as the body housing 112 rotates downward about the pivot point 155, the torsion spring 502 provides a torsional bias.

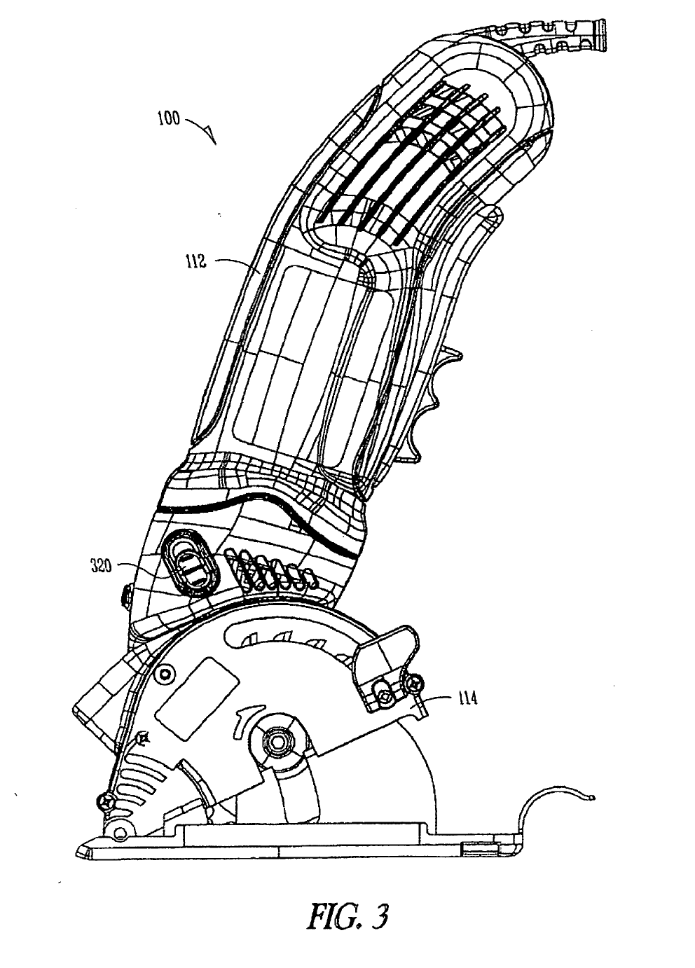

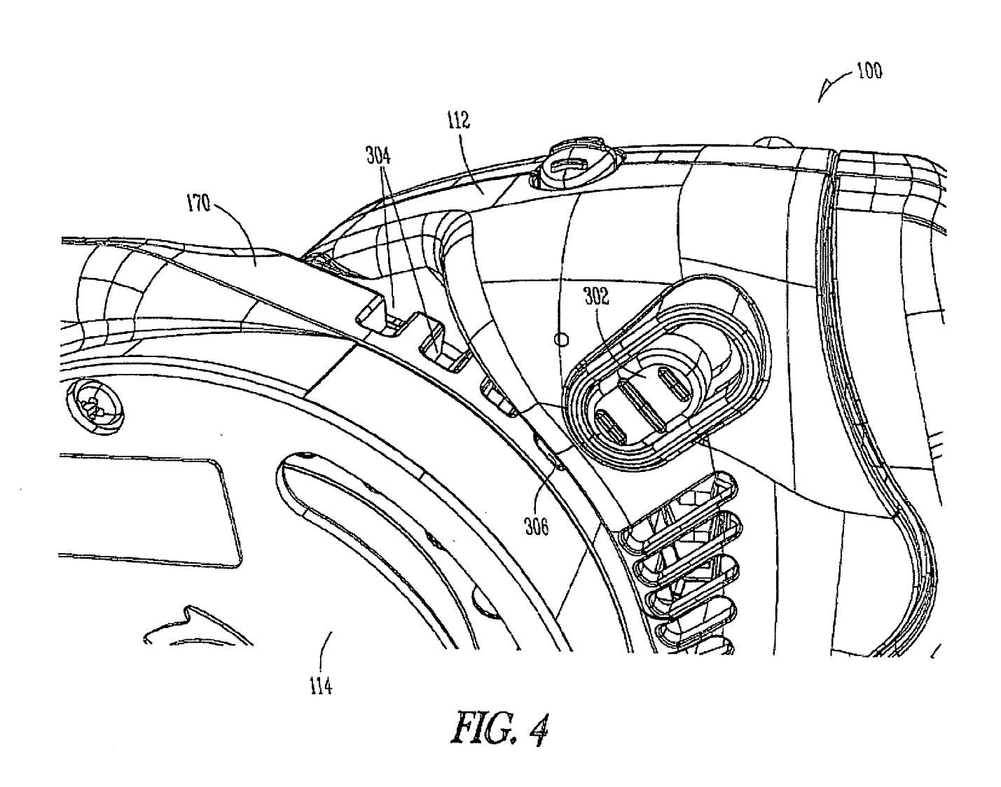

FIG. 3 shows another side view of the saw 100, whereas FIG. 4 shows a perspective view of a portion of the saw 100. Referring also to FIG. 1, the cutting head 114 is at least partially rotatable relative to the body housing 112 allowing a user to set the angle between the body housing 112 and the cutting head 114 for comfort and for different cutting situations, such as floors, walls, ceilings, and the like. The cutting head 114 is designed to pivot and lock in various locations allowing the operator to select the preferred hand position when cutting. These feature aides in creating the “hand shake” grip position to minimize fatigue and Carpal Tunnel Syndrome (“CTS”) risks. In some examples, the motion can be spring loaded but may also be manually or automatically locked in a fixed position(s).

For example, the saw 100 can include a plurality of indentations 304 and an engaging member 306 that can selectively engage one of the plurality of indentations 304 (FIG. 4) so as to fix the position of the cutting head 114 relative to the body housing 112. This allows the rotating cutting head 114 to operate free-flowing within a limited range for ergonomic benefit, be set in multiple fixed positions or to be set at any location. For example, FIG. 3 the body housing 112 can rotate relative to the cutting head 114 and lock in a selected position, while in FIG. 1, the body housing 112 is set at a lower angle relative to the cutting head 114.

In various embodiments, different numbers of indentions can be provided. In one embodiment, the plurality of indentations 304 are located and spaced along the upper surface of the upper guard 170 of the cutting head 114. Engaging member 306 can be a post or other protrusion, for example. Engaging member 306 can be operatively coupled to an actuator 302 allowing a user to raise and lower the engaging member 306 into one of the plurality of indentations 304 as they rotate upper guard 170 relative to the housing 112.

FIG. 5 shows schematically a portion of the inner mechanisms of the saw 100, in accordance with one embodiment. The saw 100 includes the motor 202 which engages the plurality of gears 351 to drive the blade 150. The motor 202, for example, can be a 120 Volt universal AC motor operating at 3.3 Amps rated or higher, with a no-load motor speed: 26,000-33,000 RPM. Of course, those skilled in the art will recognize many modifications that may be made to this configuration, without departing from the scope or spirit of what is described herein. In this embodiment, the motor 202 is mounted parallel to the longitudinal orientation of the housing 112. The plurality of gears 351 cause the blade 150 to operate in parallel to the motor's output shaft. In other words, the rotational axis of the blade 150 is perpendicular to the rotational axis of the shaft of the motor 202. The plurality of gears 351 can comprise, for example, a motor shaft gear, reduction gear, worm pinion, worm gear, etc. The bearings can be high speed: for example, 32,250 RPM max for spindle bearings, and 37,500 RPM max for reduction shaft bearings. Those skilled in the art will recognize many modifications that may be made to this configuration, without departing from the scope or spirit of what is described herein.

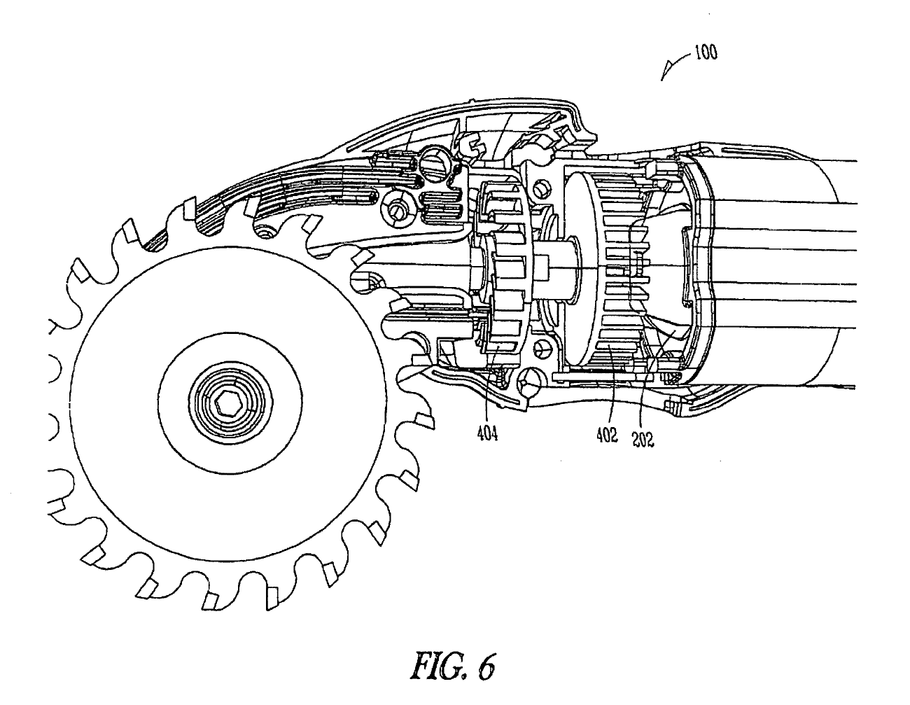

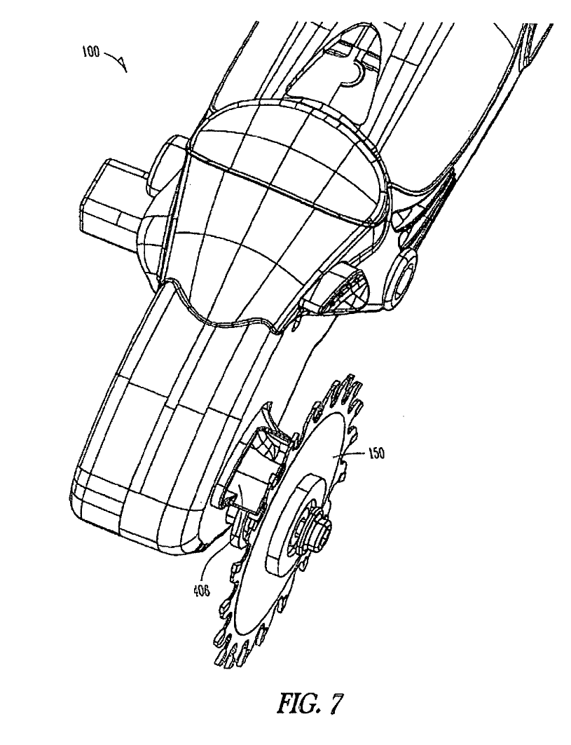

FIG. 6 shows a partial cut-away view of a portion of the saw 100. FIG. 7 shows a perspective view of a front end of the saw 100 with the cutting head 114 removed for clarity. In one embodiment, the motor 202 drives a cooling fan 402 and a vacuum extraction fan 404 which draws saw dust into a channel 406 and out a sawdust exit port (not shown). In one embodiment, a dust collection bag can be used to collect dust from the dust exit port. Channel 406 is located behind the saw blade 150 so as to collect dust during use. The fan 404 also cools the gear box area improving service life.

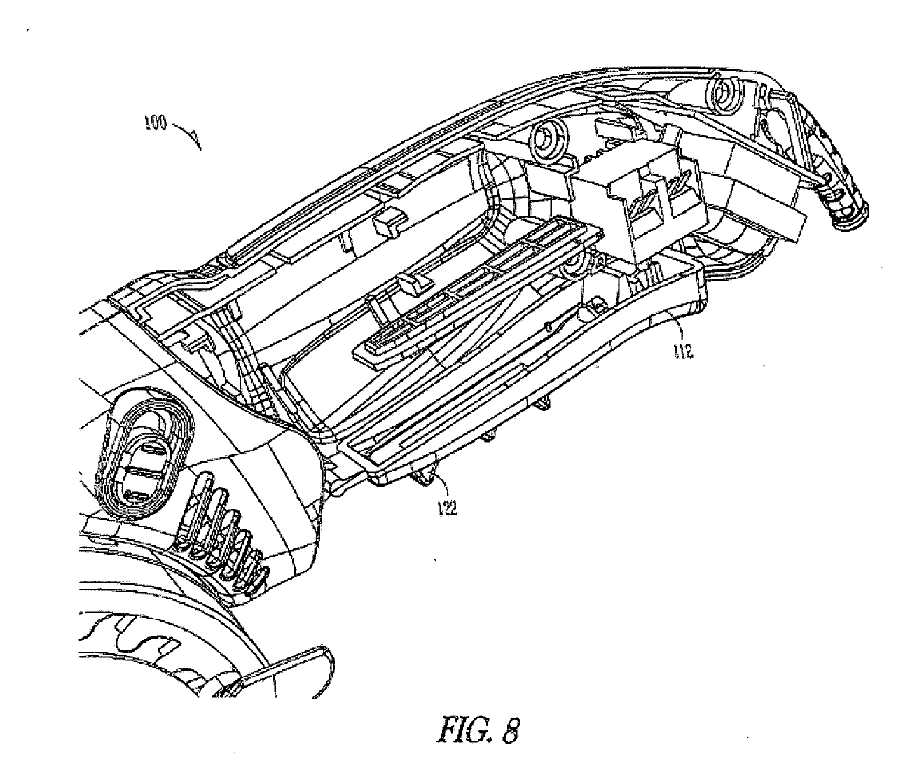

The saw 100 is designed for forced airflow via fan 402 near the motor shaft bearing and exhausting air through vents 126 and 128 at the perimeter of the vacuum extraction fan 404. The exhaust and intake vents 126 and 128 are positioned such that the user will not block the airflow with a hand during normal operation. FIG. 8 shows a cut-away view of a portion of the saw 100 showing details of the switch 122, in accordance with one embodiment. The switch 122 includes a slide-action safety power trigger. The switch 122 operates such that the switch 122 is first slid backwards towards the rear of the saw 100 and then the switch 122 is enabled to be depressed to activate the switch 122 turning the tool to “on”. The switch 122 cannot be depressed when it is in its forward biased position as a safety feature. The switch 122 can be spring-loaded to keep it biased forward. Those skilled in the art will recognize many modifications that may be made to this configuration, without departing from the scope or spirit of what is described herein.

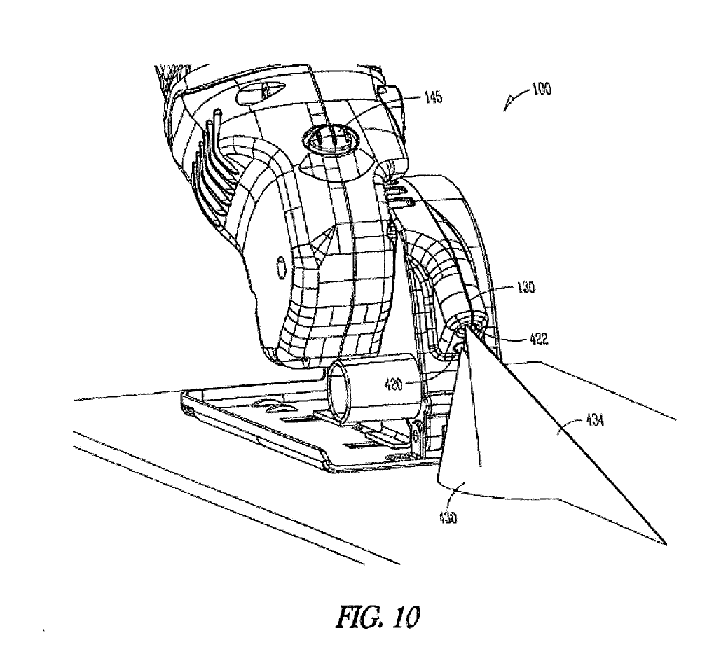

FIGS. 9 and 10 show the operation of a light feature of the saw 100, in accordance with one embodiment. Within a housing 130 are an LED 420 and a laser 422, which can both be powered through the tools main power source, for example. The LED 420 is positioned and angled so as to illuminate a diffuse area 430 in front of the saw 100. The laser 422 is positioned and angled to provide a precise line of light 434 to indicate a cutting line of the saw blade 150 of the saw 100. In this example, both the LED 420 and the laser 422 are enclosed within the housing 130 and mounted towards the front of upper guard 170 of the cutting head 114. In other examples, the lights can be mounted separately or to different portions of the saw 100. In one embodiment, one or both lights 420 and 422 can be in a removable, battery-powered housing, for example.

In some examples, the laser 422 can project a focused line 0″ to 12″ in front of the cutting path. This will be used as an aide to keep the tool square to the cut line. The laser 422, for example, can include a Wavelength and Class of 635-650 nm, Class IIIa. A power switch 145 for the light(s) on the saw 100 can have three positions: OFF, Laser ON, Laser & LEDs ON. This may also be accomplished with a selector switch and an independent ON/OFF switch, for example.

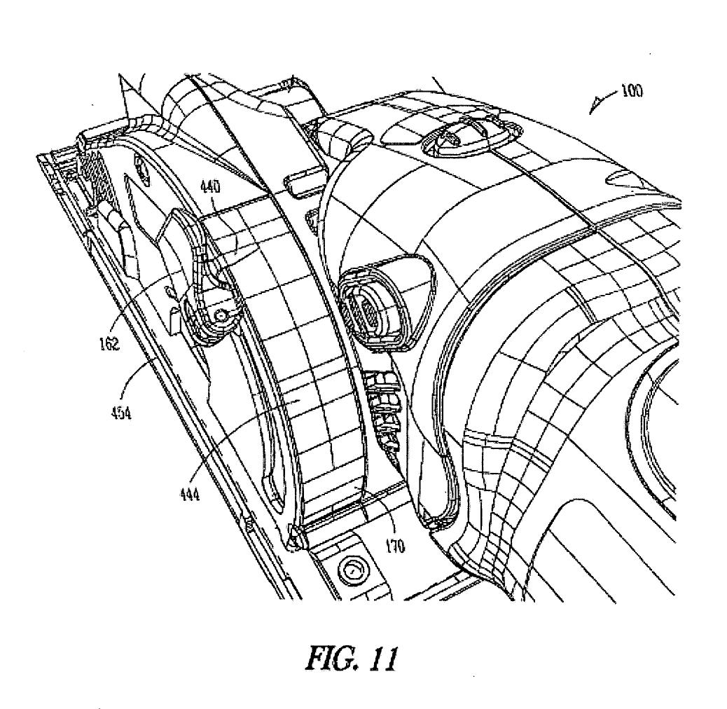

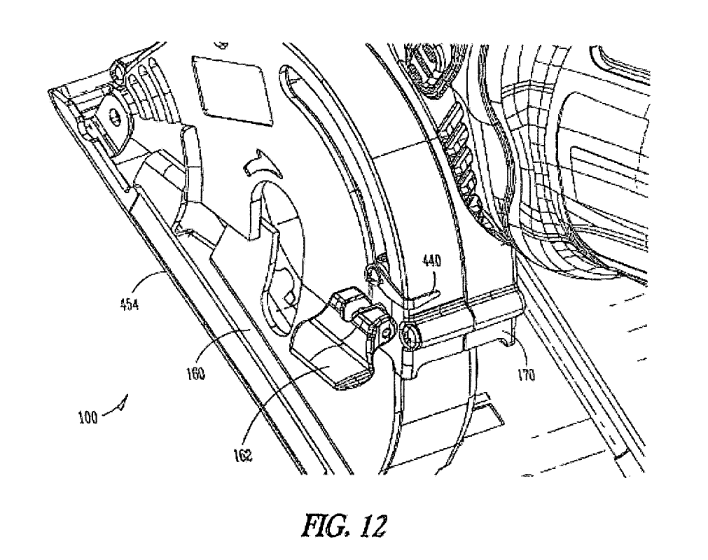

FIGS. 11 and 12 show a feature to set the cutting depth of the saw 100. A depth indicator 440 slides along a top surface of the upper guard 170 of the cutting head 114. The depth indicator 440 can indicate both depth of cut as well as be used to determine the length of the plunge cut. The depth indicator 440 is operatively coupled to latch 162 and can be locked into place via the latch 162 to enable the setting of a specific depth of cut as indicated on an identifying measured scale 444. In one example, the latch 162 flips in and out to latch and release, respectively, the latch 162, so as to move the latch 162 to different locations along guard 170. Referring also to FIG. 9, the latch 162 includes a bottom surface 163 that contacts a top surface 165 of guard 135 when the guard 135 of the cutting base 160 has rotated up enough relative to the upper guard 170 to contact the latch 162.

In one embodiment, the saw 100 also includes a length of cut indicator 454 marked on the base 160 of the saw 100, which identifies the start and end points for the blade's exposure for the depth setting indicated by scale 444 as indicated by depth indicator 440. In use, a user refers to depth indicator 440 to ascertain the depth of cut on the scale 444. Scale 454 corresponds to scale 444 such that by referring then to scale 454 the user can know the beginning and end points of an initial plunge cut, for example.

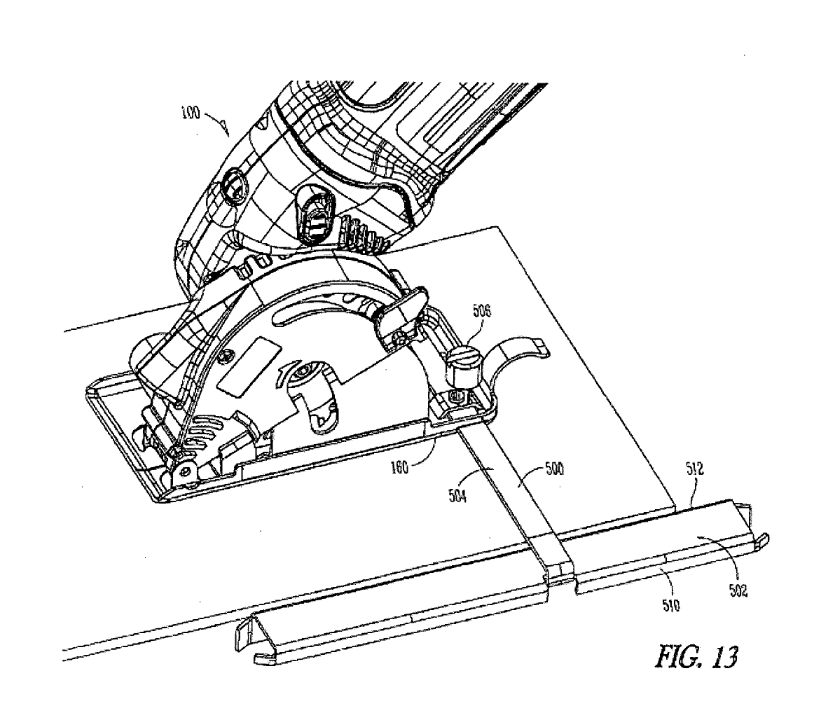

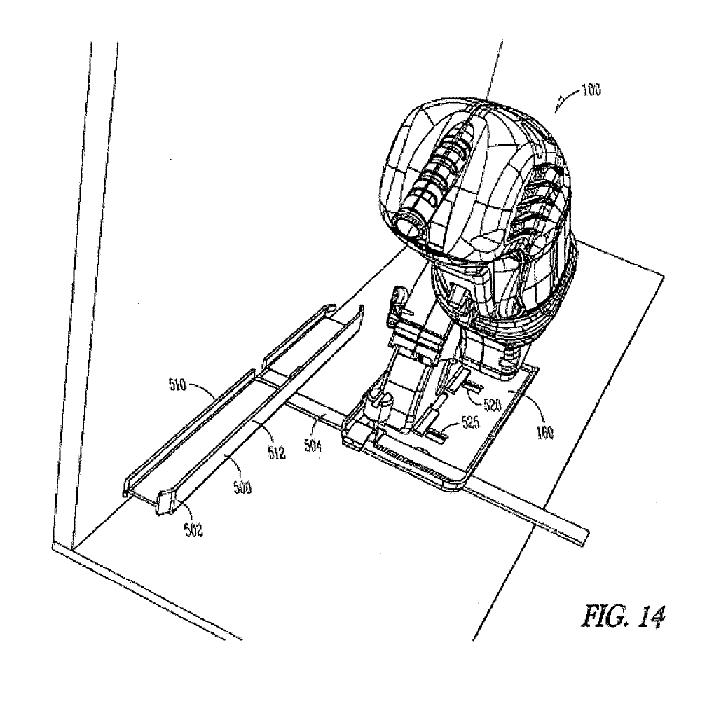

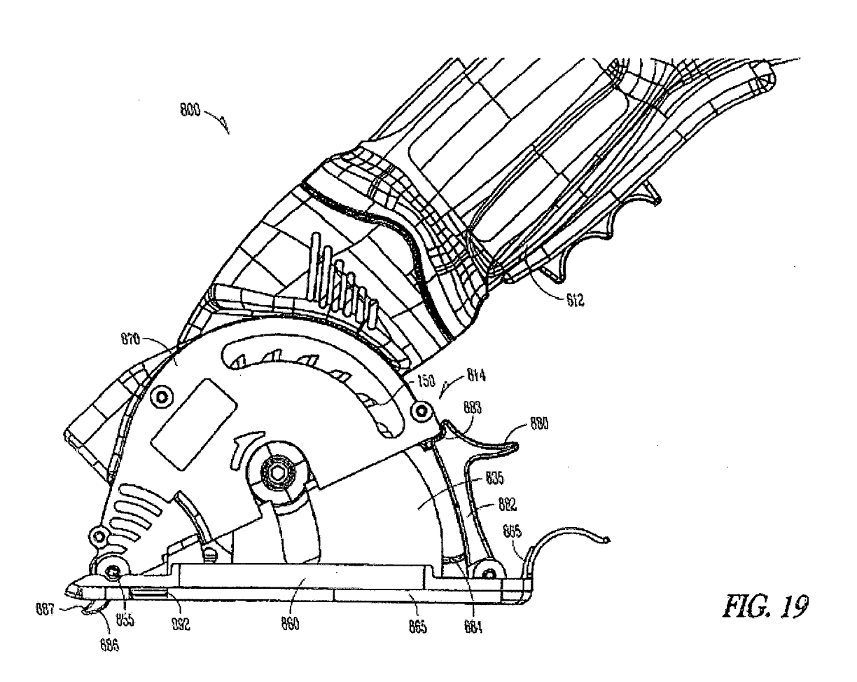

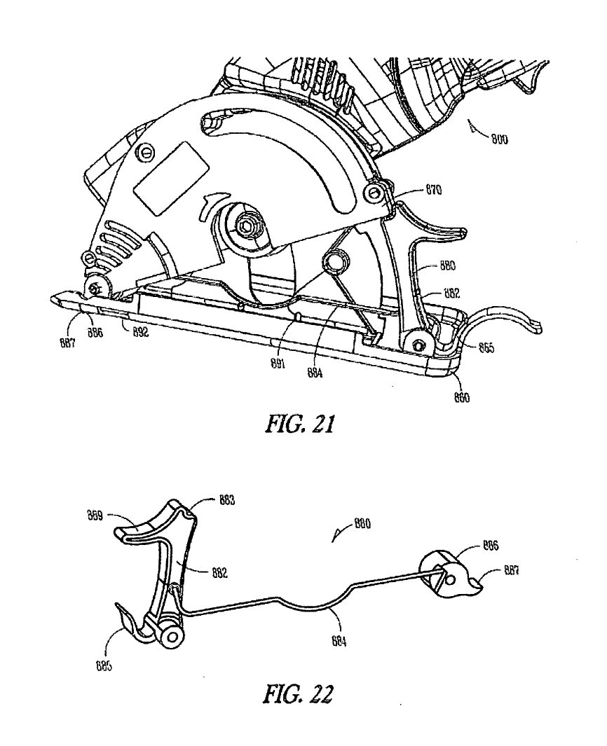

FIGS. 13 and 14 show a cutting guide member 500 for a saw 100, according to one embodiment of the present invention. Cutting guide member 500 includes a straight edge member 502 attached perpendicularly to an arm 504. The arm 504 is removably coupled to the lower cutting base 160 using a screw 506, for example. In other embodiments, an arm can be coupled to a front area of the cutting base 160 (See slot 892 of FIGS. 19 and 21, for example). In one example, the arm 504 can have an adjustment range of 0″-6″. Those skilled in the art will recognize many modifications that may be made to this configuration, without departing from the scope or spirit of what is described herein.

Straight edge member 502 is flat on sides 510, 512 allowing both inside and outside cutting. This facilitates its use from the edge of a work piece (FIG. 13), or within a right angle interior cut, such as sliding the exterior guide surface along a wall, to make a cut in a floor, for example (FIG. 14).

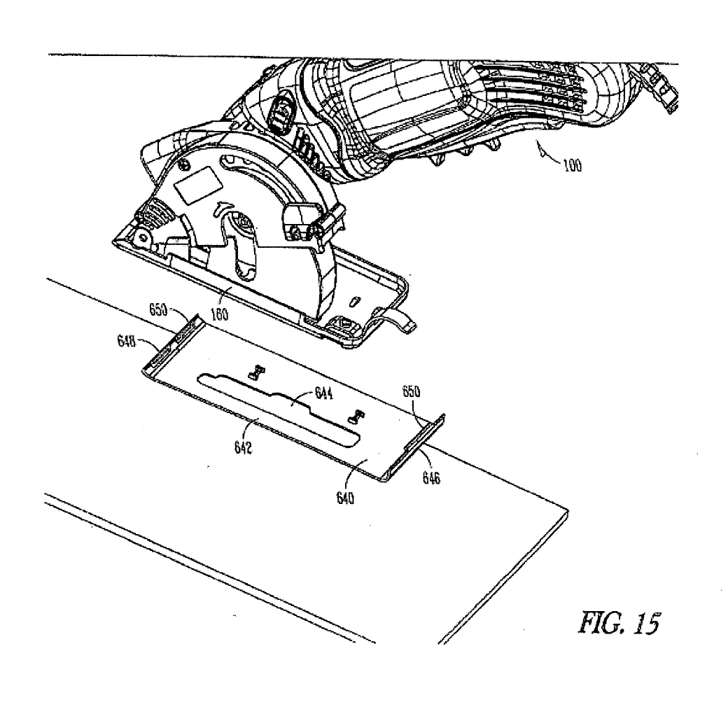

FIG. 15 shows a perspective view of an accessory 640 for the saw 100, in accordance with one embodiment of the present invention. Accessory 640 includes a member configured to reduce scratching of a work piece. The accessory 640 includes a generally planar body 642 having a slot 644 for the saw blade to go through. The front and back ends 648 and 646 include clips 650 to clip to a bottom surface of base 160 of the saw 100. When the accessory 640 is mounted it covers the bottom surface of base 160 and helps to eliminate/reduce scratching and scuffing of the work piece.

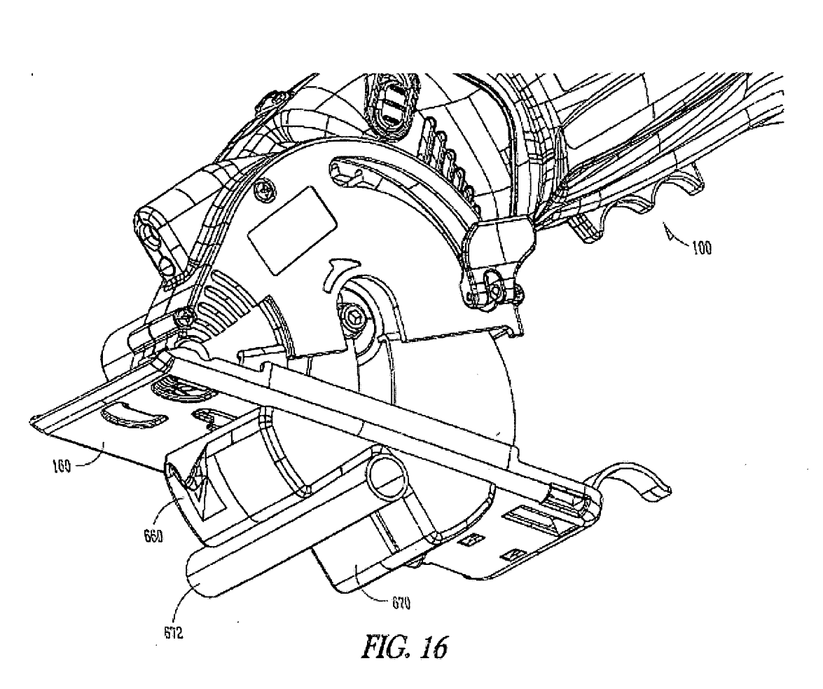

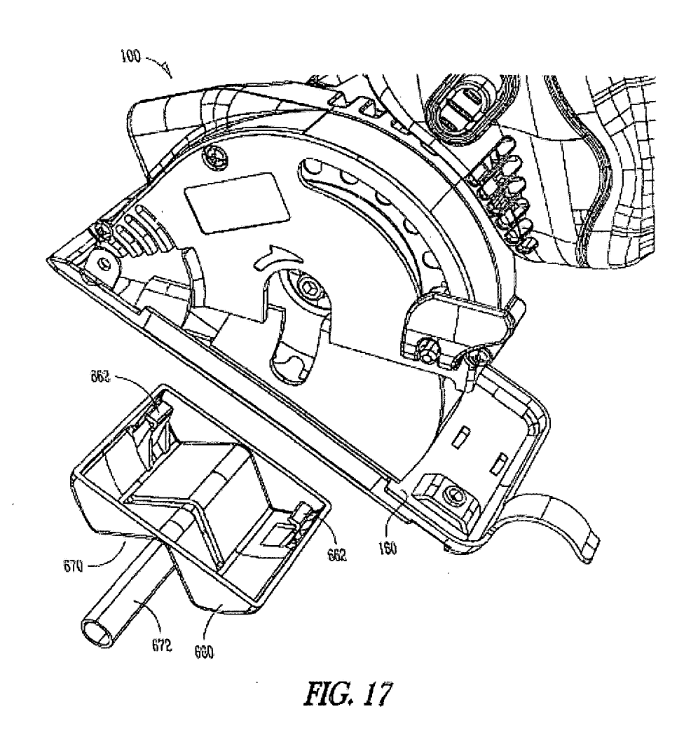

FIGS. 16 and 17 show views of an accessory 660, according to one embodiment. Accessory 660 includes one or more tabs 662 to mount to base 160 of the saw 100. Base 160 can include corresponding mounting holes for the tabs 662. Accessory 660 includes an outer surface defining a V-shape 670. This facilitates cutting of round objects, such as pipe 672. In other embodiments, other accessories can be provided for the saw 100. The base 160 includes mounting holes (i.e., holes 520, 525 in FIG. 14), edges, and other mounting means, defining a mounting area for the base 160, to allow a variety of accessories, such as accessories 500, 640, and 660 to be selectively mounted thereon.

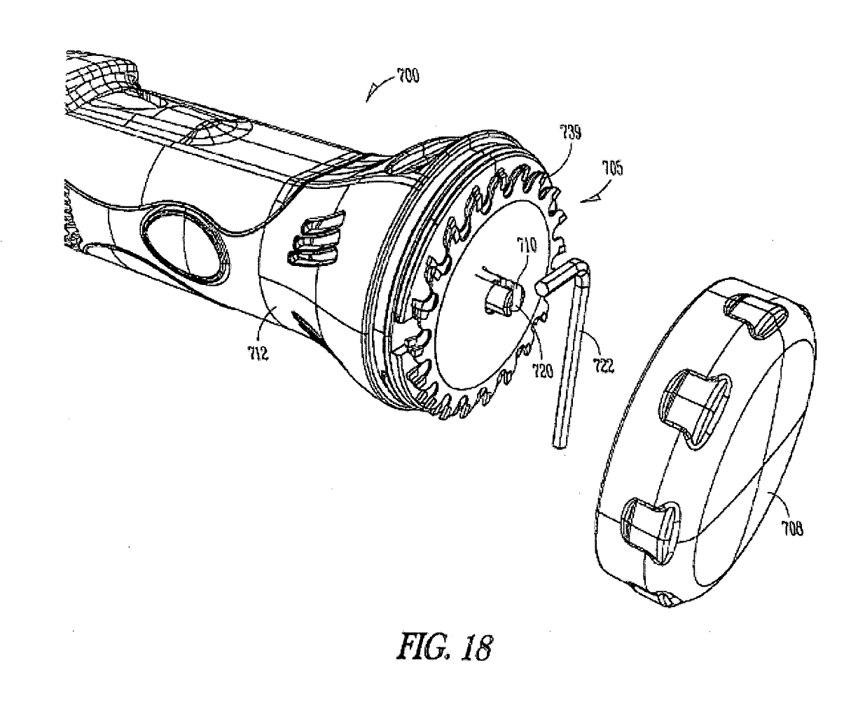

FIG. 18 shows a perspective view of a saw 700 according to one embodiment. The saw 700 can include any of the features discussed above. The saw 700 includes a body 712 and a storage area 705 at an end of the body 712. A removable cap 708 is threaded over area 705. Blades and tools can be stored within a portion of the storage or within the cap 708, for example. A post 710 can be used to mount saw blades 739 with a notch 720 in the post to receive and hold a tool, such as Allen wrench 722.

FIG. 19 shows a side view of a saw 800, in accordance with one embodiment. The saw 800 can include any components of the saws discussed above, and certain other details will be omitted for the sake of clarity. The saw 800 generally includes a body housing 812 and a cutting head 814. The saw blade 150 is coupled to the body housing 812 with the cutting head 814 enclosing a blade 150. The cutting head 814 fully surrounds the saw blade 150, when not in use. The cutting head 814 includes an upper guard 870 that covers the upper surface of the saw blade 150 and a lower cutting base 860. A cutting base 860 includes a cutting surface 865 and a guard portion 835 which partially surrounds and covers the lower portion of the saw blade 150. The lower cutting base 860 is rotationally coupled to the upper guard 870 of the cutting head 814 at pivot point 855.

In one embodiment, the saw 800 includes a guard lock mechanism 880 (FIG. 19). The guard lock mechanism 880 acts to keep the upper guard 870 from rotating toward the cutting base 860 and exposing the saw blade 150 when the saw 100 is not in use.

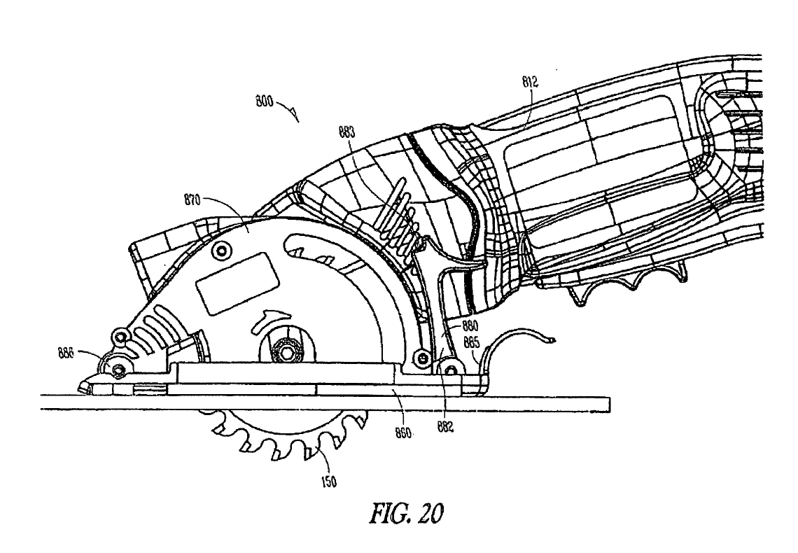

Referring also to FIGS. 20, 21, and 22, a guard lock mechanism 880 includes a lock member 882 that is rotationally coupled to cutting base 860 and biased towards a front of the saw (in the position of FIG. 19) by a tail 885. The guard lock mechanism 880 further includes a linkage 884 that is coupled to lock member 882 and extends to an actuator 886. The actuator 886 is rotationally mounted at or near pivot point 855 of saw 800. In use, as the saw 800 is placed onto a surface of a work piece, a tongue 887 of the actuator 886 contacts the work piece and rotates the actuator 886 (clockwise, FIGS. 19-21). The tongue 887 rotates out of the way and pushes, via linkage 884, the lock member 882 backwards. This releases upper guard 870 from contact with an upper shoulder 883 of the lock member 882. Once released (FIG. 20), the upper guard 870 can rotate downwards towards the cutting base 860, exposing the saw blade 150. When the saw 800 is removed from the work piece, tail 885 pushes lock member 882 and actuator 886 (via linkage 884) back to their biased positions with lock member 882 holding upper guard 870 and cutting base 860 apart. Lock member 882 can also include a projection 889 to manually control the lock member 882. In other examples, the lock member 882 can be biased forward by springs, for example, or the actuator 886 can be spring-loaded to pull the lock member 882 forward.

As can also be seen in FIG. 21, in this example, a spring 891 between the upper guard 870 and the cutting base 860 is located near a rear portion of the two members 870 and 860. In various embodiments, the saws discussed above can include a mini circular saw designed to be very portable and lightweight. The saw 800 can include a pivoting head design allowing convenient use while kneeling, standing, or working overhead. Tools and blades can be stored on-board, in some embodiments. The blade guard allows blade changing without removing the guard. The guard incorporates a depth of cut and cut length indicator. The guard also allows for accessory attachment.

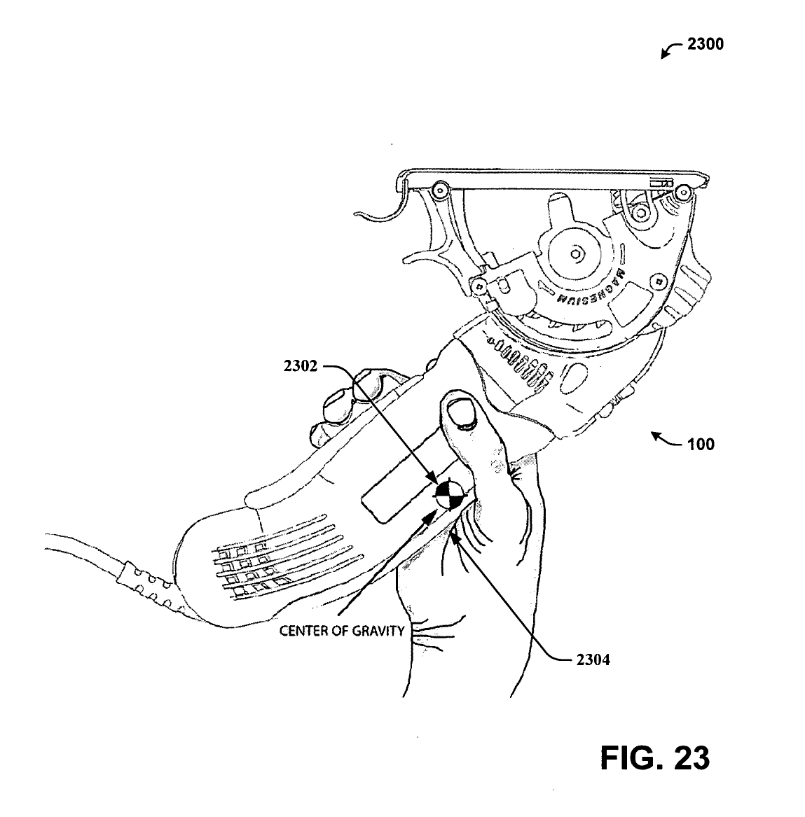

As shown in FIG. 23 a center-of-gravity 2302 of a saw 100 can be adjusted so that the center-of-gravity 2302 is approximately centered in an operator's palm 2304 of the operator's hand. Most circular saws rest horizontally on a surface so that the user's arm is not substantially fatigued when operating the saw 100. However, the plunge saw 100 is intended to work in various positions, on horizontal surfaces, where a blade pointed downward; on vertical surfaces, such as walls; and in overhead positions such as ceilings. The inventor(s) recognized that if the center of gravity 2302 (CG) of a saw 100 could be adjusted so that the CG 2302 was placed on the center of the operator's palm, the operator would have less fatigue trying to overcome the overturning moment experienced with other prior art saws. Therefore, when the saw 100 is used overhead at various angles or not resting on the workpiece the operator can manually center of the CG 2302 using a weighted pull out mechanism (not shown) so that the saw 100 balances in the operators palm. Other designs, both manual and automated are well known by those of skill in the art to balance the center of gravity of a device. This embodiment is described in sufficient detail to enable those skilled in the art to practice the invention, and it is to be understood that the embodiments may be combined or that other embodiments may be utilized and that structural changes may be made without departing from the spirit and scope of the present invention.

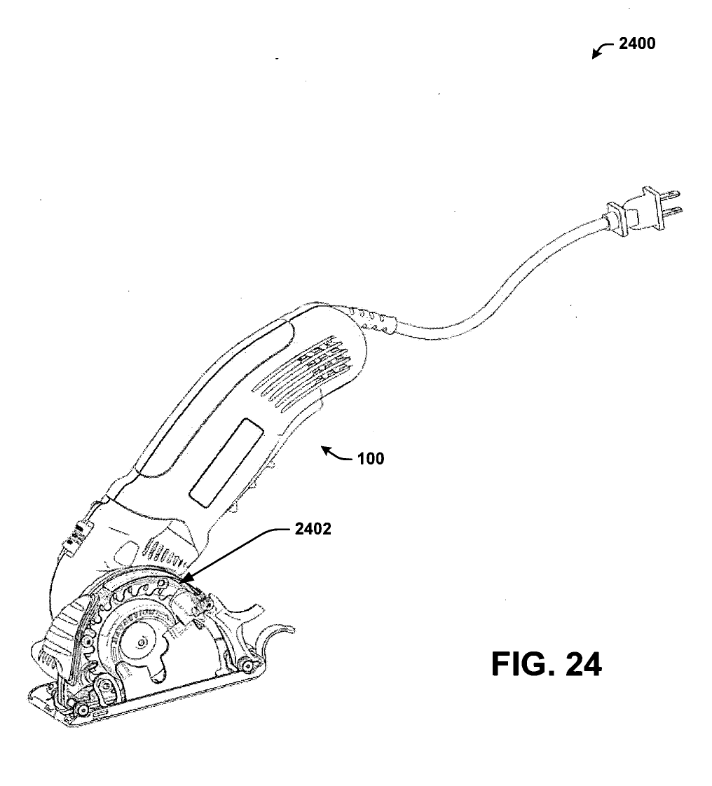

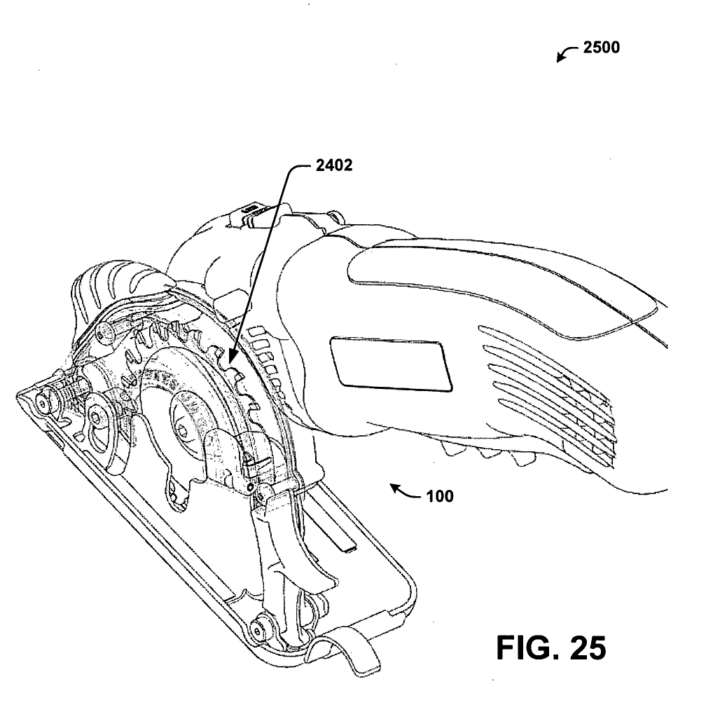

As illustrated in FIGS. 24 and 25 the inventor recognized that by having a transparent guard 2402 that the operator would be able to see through the guard 2402 or 2502 so that the operator could more accurately cut the workpiece and receive immediate visual feedback regarding the accuracy of the cut. The transparent guard 2402 can be made of materials comprising ABS, transparent engineering thermoplastics, high heat polycarbonate, layered polymer nano-composites, LEXAN™, which is manufactured by General Electric Corporation and the like.

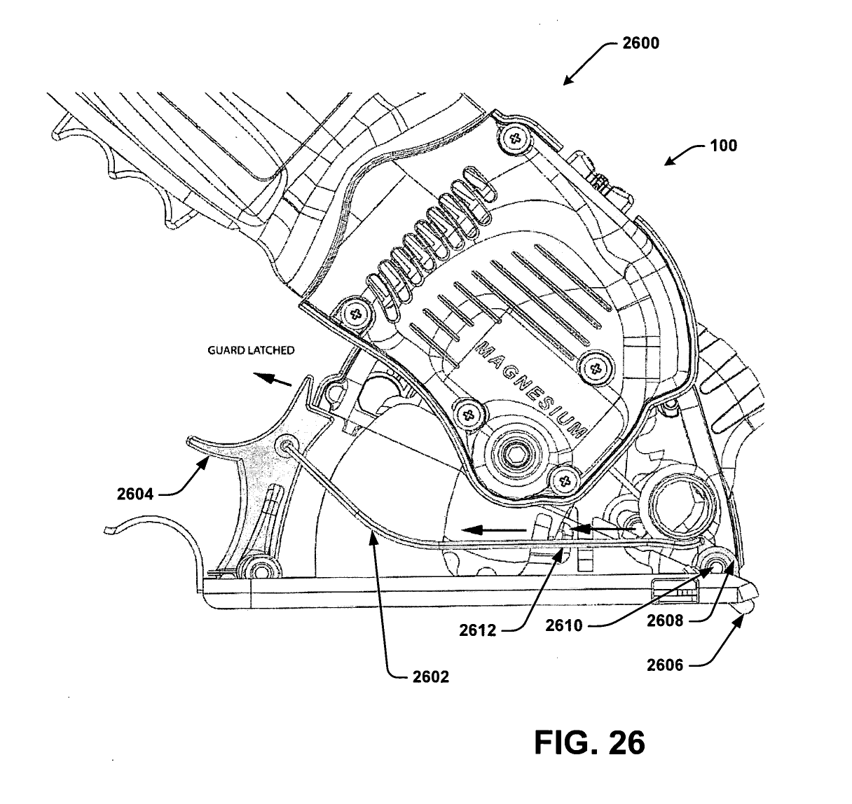

Illustrated in FIG. 26 is a mechanism that allows an operator to fully utilize and operate a saw 100 with only one hand. Often the operator wants to hold an object in an upright position with one hand prior to turning on and operating the saw 100 with the opposite hand. Prior art saws require that a safety latch or lock out mechanism be released with a second hand prior to operating the saw. The present invention 2600 overcomes the prior art limitations and allows the operator to actuate and operate the saw 100 with a single hand. An auto unlatch button 2606 is located in a front portion of the saw 100 and allows an unlatch lever 2608 to rotate about a pivot point 2610 to move a cylindrical bent rod 2612 forward as shown to release a lock member 882 to be released when the unlatch lever 2608 is engaged with a workpiece. Of course, those skilled in the art will recognize many modifications that may be made to this configuration to allow one handed operation, without departing from the scope or spirit of what is described herein that can meet the requirements of US safety agencies and other international safety agencies.

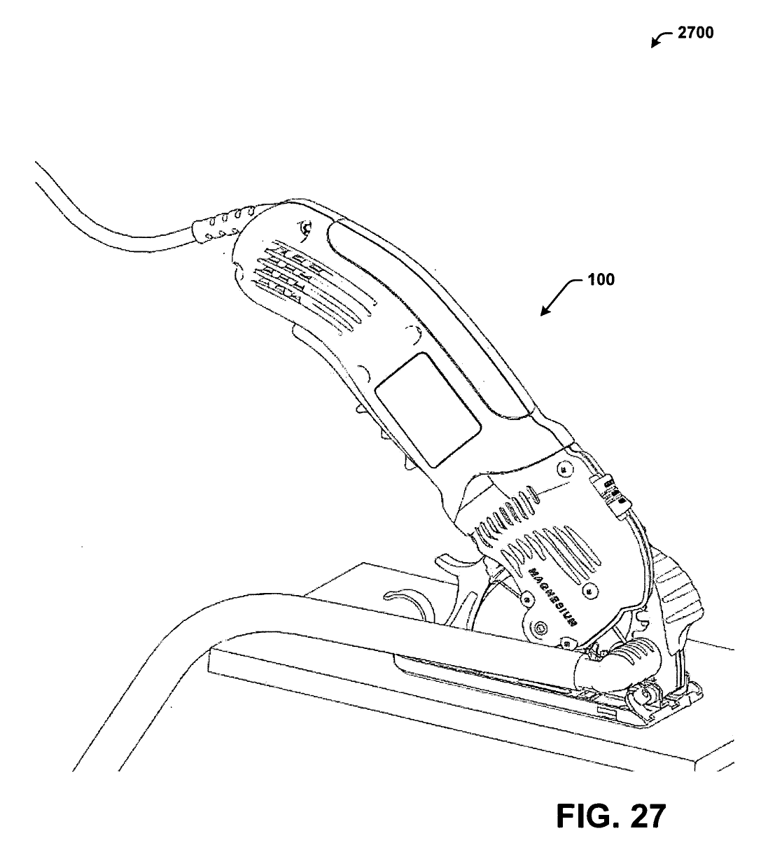

FIG. 27 illustrates another embodiment of the present invention wherein the saw 100 utilizes a smooth hose 2702. The inventor(s) recognized that the smooth hose 2702 is less likely to get “hung up” on a protruding edge or surface than a ribbed hose that often inhibits the movement of the saw 100. This thereby leads to a more useful saw 100 and reduces the mistakes that often accompany a hose getting hung up.

FIG. 28 illustrates yet another embodiment of the present invention. The inventor recognized that may of the prior art saws clog with saw dust at the saw blade opening. By forming a tunnel dust feature 2802 within a cutting base 860 and a cutting surface 865 that the tunnel dust feature 2802 substantially reduces the likelihood of a cutting opening 2804 clogging with saw dust. This is because rather than having the saw dust drop through the saw kerf or cut the saw dust can drop down onto the workpiece and run through the tunnel dust feature 2802 without inhibiting the saw 100. The tunnel dust feature 2802

The tool can have optional right angle handle of a design that can be rotated for multiple angles for left or right hand use. Some embodiments include 2-speed control without torque feedback with the speed control located remotely from the power switch.

In another embodiment, a saw can incorporate an interchangeable power head that will allow the tool to convert between a spiral saw to a mini-circular saw. For example, the power heads will automatically latch in-place when installed and be removable with a single release button. Other attachments such as a sander head are possible as design enhancements. The saw will allow for additional accessories such as a flexshaft, plunge base, circle cutter, etc.

In use, the saws discussed above, the tools can be used to cut flooring. For example, wood flooring that is typically ¾″ thick is currently cut using circular saws in the 7″ to 5¼″ size category, for example, as well as chop saws, and table saws. Laminate flooring less than ½″ thick and as thin as ¼″ can be cut, and under floor pads can be cut as well, as an alternative to a utility knife. The saws can cut vinyl and vinyl tile as well as roofing materials, wood, vinyl, and aluminum siding, plywood, decking, chipboard, insulating board, cement board, countertop materials, ceramic wall tile, various sheet stock such as Plexiglas, fiberglass, and acrylics, plenum & round pipes and can be used as an alternative to tin snips, jig saws, pneumatic nibblers, or hacksaw. The saw can also be used for making cuts in thin flat metal/metal fabrications. It can be used for making full width and full length cuts in drywall, as well as cutting out utility box openings, light switch/outlet openings, and recessed vanity mirror openings.

A safety grip interlock can be included. A shaft lock can be provided to help change the blades of the saw. To change a blade, for example a user can press against the shaft lock to prevent the blade from turning and then can unscrew a bolt holding the blade in place.

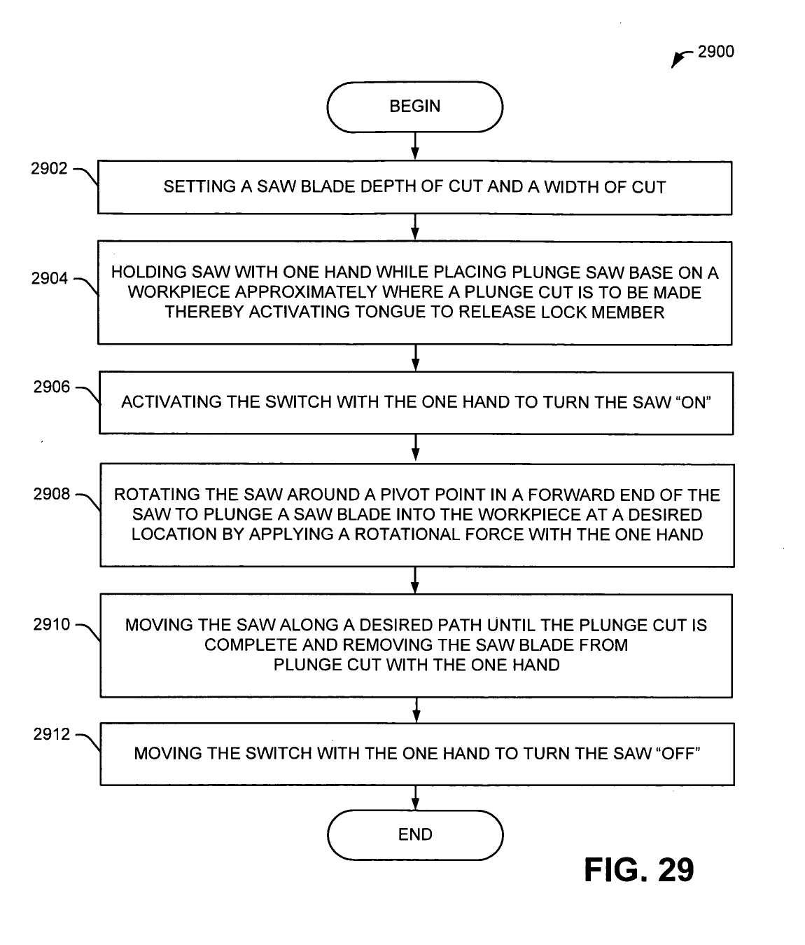

In accordance with yet another aspect of the present invention, a method of operating a plunge saw 100 is provided, as illustrated in FIG. 29 and designated at reference numeral 2900. Although the methodology 2900 is illustrated and described hereinafter as a series of acts or events, it will be appreciated that the present invention is not limited by the illustrated ordering of such acts or events. The method 2900 with be described with respect to previous FIGS. and descriptions. For example, some acts may occur in different orders and/or concurrently with other acts or events apart from those illustrated and/or described herein, in accordance with one or more aspects of the present invention. In addition, not all illustrated steps may be required to implement a methodology in accordance with the present invention. Furthermore, the methodologies according to the present invention may be implemented in association with the formation and/or processing of structures illustrated and described herein as well as in association with other structures not illustrated.

The method 2900 begins at 2902 with setting a saw blade depth of cut and a width of cut, at 2904, the remainder of the method 2900 can be utilized by the operator with one hand. At 2904, the operator can hold the saw 100 with one hand while placing plunge saw base 160 on a workpiece approximately where a plunge cut is to be made, thereby activating a tongue 887 of the actuator 886 contacts the work piece and rotates the actuator 886 (clockwise, FIGS. 19-21). The tongue 887 rotates out of the way and pushes, via a linkage 884, the lock member 882 backwards. This releases upper guard 870 from contact with an upper shoulder 883 of the lock member 882. Once released (FIG. 20), the upper guard 870 can rotate downwards towards the cutting base 860, exposing the saw blade 150.

At 2906, the operator can activate the switch with the one hand to turn the saw “on” in order to make the desired cut. The power/speed control switch 122 is centrally located at the bottom of the saw to be convenient to operate with either hand. In other words, the power/speed control switch 122 is located such that it can be activated with either hand, allowing one-handed operation. A double action (trigger with secondary interlock) can be utilized as a safety measure. Alternatively, other types of switches may be employed and are contemplated as falling within the scope of the present invention.

At 2908, the operator can rotate the saw 100 around a pivot point 155 located at a forward end of the saw 100 to plunge a saw blade 150 into the workpiece at a desired location by applying a rotational force with the one hand. The saw blade 150 plunges into a workpiece in a rotational arc thereby exerting both a lateral and vertical force that reduces the likelihood of saw kick back. At 2910, the operator moves the saw 100 along a desired path until the plunge cut is complete and removes the saw blade 150 from plunge cut with the one hand. Wherein, the operator can move the switch with the one hand to turn the saw “off” and the method ends.

When the saw 800 is removed from the work piece, tail 885 pushes lock member 882 and actuator 886 (via linkage 884) back to their biased positions with lock member 882 holding upper guard 870 and cutting base 860 apart. Lock member 882 can also include a projection 889 to manually control the lock member 882. In other examples, the lock member 882 can be biased forward by springs, for example, or the actuator 886 can be spring-loaded to pull the lock member 882 forward.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled. Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A plunge saw comprising:
a body housing enclosing a motor;
wherein the plunge saw rotates about a forward pivot point while a lower cutting base bottom planar surface remains in contact with a workpiece; and
a saw blade operatively coupled to the motor;
wherein the saw blade plunges into a workpiece in a rotational arc thereby exerting both a lateral and vertical force that reduces the likelihood of saw kick back;
wherein the saw can be turned on, operated and turned off with a single hand.

2. The plunge saw of claim 1, wherein the plunge saw guard lock mechanism is configured to keep a upper guard from rotating toward the cutting base and exposing the saw blade when the saw is not in use.

3. The guard lock mechanism of claim 2, wherein the guard lock mechanism includes a linkage assembly that is configured to release the guard lock mechanism to expose the saw blade by placing the saw base onto a surface of a work piece activating a tongue which is linked to the lock mechanism, wherein the guard does not have to be manually lifted.

4. The plunge saw of claim 3, wherein a cutting head includes an upper guard that covers the upper surface of the saw blade and a lower cutting base, wherein the cutting base includes a cutting surface and a guard portion which partially surrounds and covers the lower portion of the saw blade.

5. The plunge saw of claim 1, wherein the body housing includes a switch to activate the saw in both the on and off position, wherein the switch is configured to control power and speed and allow one-handed operation with either a right or left hand and/or the saw includes a tunnel dust feature that reduces the likelihood of a cutting opening clogging with saw dust

6. The plunge saw of claim 1, wherein a cutting head is rotatably coupled to the body housing, wherein the cutting head is configured to be rotatable and fixed relative to the body housing in at least two different positions.

7. The plunge saw of claim 1, wherein transparent components can comprise an upper guard, a guard portion and a lower cutting base to allow visualization of the cutting process.

8. A plunge saw comprising:
a body housing enclosing a motor;
wherein the plunge saw rotates about a forward pivot point while a lower cutting base bottom planar surface remains in contact with a workpiece;
a saw blade operatively coupled to the motor; and
wherein the saw blade plunges into a workpiece in a rotational arc thereby exerting both a lateral and vertical force that reduces the likelihood of saw kick back;
wherein the saw can be turned on, operated and turned off with either a left or a right hand, wherein the plunge saw center-of-gravity can be adjusted manually or automatically to remain approximately in the center of the operator's hand.

9. The plunge saw of claim 8, wherein the body housing includes a switch to activate and/or lock the saw in both the on position during operation and off position, wherein the switch is configured to control power and speed and allow one-handed operation with either hand.

10. The plunge saw of claim 8, wherein the cutting base remains in contact with the workpiece as the saw blade is plunged into the workpiece by rotating the saw about the pivot point, wherein the lower cutting base is rotationally coupled to the upper guard at the pivot point proximate a front end of each of the lower cutting base and the upper guard.

11. The plunge saw of claim 8, wherein the saw can be turned on, operated and turned off with a single hand and/or the saw includes a tunnel dust feature that reduces the likelihood of a cutting opening clogging with saw dust.

12. The plunge saw of claim 8, wherein the lower cutting base is biased to conceal a cutting surface of the saw blade above the upper surface of the cutting base, the cutting surface being exposed during cutting by pushing the body housing of the saw down such that the cutting head rotates downward toward the cutting base.

13. The plunge saw of claim 1, wherein the dust hose is smooth and approximately the same diameter along the length of the hose.

14. A method of operating a plunge saw comprising;
setting a saw blade depth of cut and a width of cut;
holding saw with one hand while placing plunge saw base on a workpiece approximately where a plunge cut is to be made thereby activating tongue to release lock member;
activating the switch with the one hand to turn the saw “on”;
rotating the saw around a pivot point in a forward end of the saw to plunge a saw blade into the workpiece at a desired location by applying a rotational force with the one hand;
moving the saw along a desired path until the plunge cut is complete and removing the saw blade from plunge cut with the one hand; and
moving the switch with the one hand to turn the saw “off”.

15. The method of claim 14, wherein the guard lock mechanism includes a linkage assembly that is configured to release the guard lock mechanism to expose the saw blade by placing the saw base onto a surface of a work piece activating a tongue which is linked to the lock mechanism, wherein the guard does not have to be manually lifted.

16. The method of claim 14, wherein transparent components can comprise an upper guard, a guard portion and a lower cutting base to allow visualization of the cutting process.

17. The method of claim 14, wherein the dust hose is smooth and approximately the same diameter along the length of the hose and/or the saw includes a tunnel dust feature that reduces the likelihood of a cutting opening clogging with saw dust.

18. The method of claim 14, wherein the lower cutting base is biased to conceal a cutting surface of the saw blade above the upper surface of the cutting base, the cutting surface being exposed during cutting by pushing the body housing of the saw down such that the cutting head rotates downward toward the cutting base.

19. The method of claim 14, wherein the wherein the body housing includes a switch to activate and/or lock the saw in both the on position during operation and off position, wherein the switch is configured to control power and speed and allow one-handed operation with either hand.

20. The method of claim 14, wherein the guard lock mechanism includes a linkage assembly that is configured to release the guard lock mechanism to expose the saw blade by placing the saw base onto a surface of a work piece activating a tongue which is linked to the lock mechanism, wherein the guard does not have to be manually lifted.
